(19) United States
(12) Patent Application Publication
(10) Pub. No.: US 2013/0103795 A1
(43) Pub. Date: Apr. 25, 2013

(54) METHODS OF ESTABLISHING COMMUNICATION IN A SENSOR NETWORK AND APPARATUS

(71) Applicants: Parag Gopal KULKARNI, Bristol (GB); Sedat GORMUS, Bristol (GB)

(72) Inventors: Parag Gopal KULKARNI, Bristol (GB); Sedat GORMUS, Bristol (GB)

(21) Appl. No.: 13/651,704

(22) Filed: Oct. 15, 2012

(30) Foreign Application Priority Data
Oct. 19, 2011 (GB) 1118074.2

(51) Int. Cl. G06F 15/16

(52) U.S. Cl. 709/217

(57) ABSTRACT

A method of establishing a communication path in a sensor network, the sensor network having a tree structure comprising a plurality of root nodes representative of access point devices in said sensor network, and at least one non-root node representative of a sensor device in said sensor network, wherein each node in said sensor network is associated with a rank value determining its position relative to other nodes, such that said non-root node has higher rank value than said root node, the method comprising forwarding a control message from each root node in a subset of said plurality of root nodes, the control message comprising a tree size value associated with said each root node in said subset, the tree size value defining the number of non-root nodes associated with each root node in said subset; and upon reception of said control message, selecting one of said root nodes in said subset to establish a communication path between said at least one non-root node, based on said tree size values of said root nodes in said subset, such that tree sizes of said each root node in said subset is substantially balanced relative to each other.

### FIELD

Embodiments described herein relate generally to establishing communication in a sensor network.

### BACKGROUND

The need to reduce carbon footprint and improve energy efficiency has greatly increased over the years. Smart Grids have been proposed in many regulated markets, for the distribution of electrical supply in a more interactive manner than is presently the case. “Smart Grid” is a term which has been adopted to describe any electricity supply network which involves principles of information feedback and interoperability. As a result, efforts to enable Smart Grid applications are gaining momentum. One of the objectives of Smart Grid implementations is to match the demand of electrical power to the available supply. This requires the flow of metering information from consumers' premises to the grid in order to identify the demand and also to provide information from a supplier to coerce consumers into adapting their demand such that it is within the remit of the available supply.

### DESCRIPTION OF THE DRAWINGS

Embodiments will now be described with reference to the accompanying drawings, in which:

FIG. 1 illustrates an example of an Automated Metering Infrastructure, AMI, network;

FIG. 2 illustrates a process of constructing a Destination Oriented Directed Acyclic Graph, DODAG, at a concentrator device in the AMI network illustrated in FIG. 1;

FIG. 3 illustrates a process of establishing a communication path between a smart meter device and a concentrator device in the AMI network illustrated in FIG. 1;

FIG. 4 illustrates a block diagram representation of a smart meter device according to an embodiment;

FIG. 5 illustrates a process of establishing communication between a smart meter device and a concentrator device according to an embodiment;

FIG. 6 illustrates a block diagram of a concentrator device according to an embodiment;

FIG. 7 illustrates a process, performed at a concentrator device, when a smart meter device joins the network of a concentrator device, according to an embodiment; and

FIG. 8 illustrates a process, performed at a concentrator device, when a smart meter device leaves the network of a concentrator device, according to an embodiment.

### DETAILED DESCRIPTION

Specific embodiments will be described in further detail in the following paragraphs on the basis of the attached figures. It will be appreciated that this is by way of example only, and should not be view as presenting any limitation on the scope of protection sought.

One of the key solutions for realising Smart Grid applications is the deployment of an Automated Metering Infrastructure (AMI), which is achieved by deploying concentrator devices in a residential neighbourhood. Smart meter (SM) devices installed in the residential properties associate and communicate with the concentrator devices which in turn relay communications to a utility provider's management system (commonly referred to as a control centre).

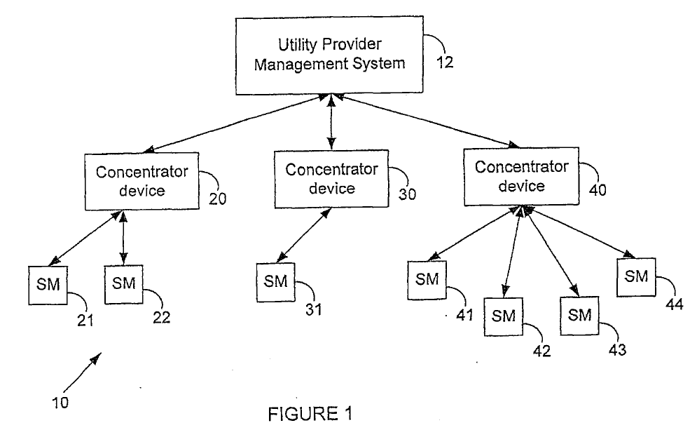

A simplified overview of an AMI network 10 is illustrated in FIG. 1. The AMI network 10 in FIG. 1 includes a utility provider's management system 12 that manages metering of data collected and routed from concentrator devices 20, 30, 40 connected to it. As described above, smart meter (SM) devices 21, 22, 31, 41, 42, 43, 44 are provided at the consumers' premises to capture energy consumption. Each of the smart meter devices can be configured to measure electricity, gas, or water consumption.

The metering data collected at the smart meter devices are transmitted to the utility provider's management system 12 via the respective concentrator devices. It would be appreciated by the skilled person that the metering data can be transmitted over a wireless medium or a wired medium.

In this illustrated example, three concentrator devices 20, 30, 40 are connected to the utility provider's management system 12, though practical implementations may include more (or fewer) concentration devices depending on the implementation. It is further noted that in practical implementations, a concentrator network may potentially comprise thousands of smart meter devices.

As illustrated in the AMI network of FIG. 1, the smart meter devices are connected to any concentrator devices that are available within their vicinity. However, this can sometimes result in overcrowding in a particular concentrator network, while other concentrator networks in the vicinity have relatively lesser smart meter devices connected to them. For example, in the AMI network 10 of FIG. 1, concentrator device 40 has four smart meter devices connected to it, while concentrator device 30 has only one smart meter device connected to it.

The skilled reader would appreciate that the AMI network can be described as a tree-like structure, with branches between nodes, each node representing a device and each branch representing a communication link in the network. Typically, the topology of such a network consists of a number of trees, each rooted to a sink node (or root node) with a number of leaf nodes (or non-root nodes) connected to it. The number of non-root nodes connected to the root node therefore defines the size of the tree.

An example of nodes in an AMI network includes low cost, low power, radio devices with limited processing power and memory. The links connecting the nodes in the network are characterised by high loss rates, low data rates, and instability. Such a network is also commonly referred to as the Low power and Lossy Network (LLN).

A routing protocol, described in “RPL: IPv6 Routing Protocol for Low Power and Lossy Networks” (T. Winter et al., http://tools.ietf.org/html/draft-ietf-roll-rpl-19) has been developed by the Internet Engineering Task Force (IETF) Routing over Low Power and Lossy Networks (ROLL) working group to facilitate tree creation in these networks.

According to the RPL protocol, a Destination Oriented Directed Acyclic Graph (DODAG) is used to maintain network station information. DODAG is a directed graph having a property that all edges are oriented in such a way that no cycles exist. Each DODAG created according to the RPL protocol is rooted at a sink node. The DODAG root (or sink node) typically is the concentrator device in the AMI network or the sink node in sensors networks.

A path from a leaf node (or non-root node) oriented toward, and terminating at, the sink node (or root node) consists of edges in the DODAG. Each node in the DODAG is associated with a rank value, such that the rank of nodes along any path to the DODAG root should decrease monotonically.

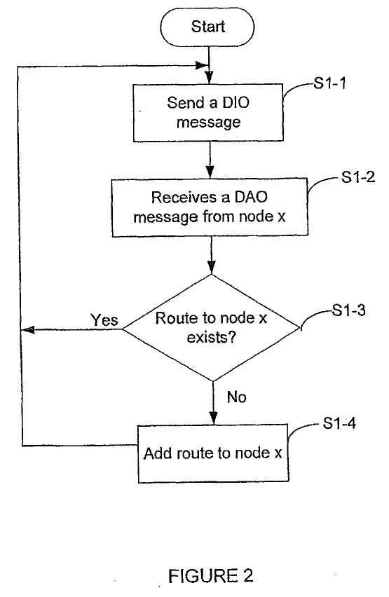

A flow diagram illustrating the process of constructing a DODAG at a root node is provided in FIG. 2.

In order to construct a DODAG, the root node will issue a control message called DODAG Information Object (DIO) in step S1-1. A DIO conveys information about the DODAG and includes:
a DODAG Identifier (DODAGID) used to identify the DODAG as sourced from the DODAG root;
a rank information used by nodes to determine their positions in the DODAG relative to each other; and
objective function, identified by an Objective Code Point (OCP), which specifies the metric used within the DODAG and the method for computing DODAG rank.

Any other node (namely a non-root node) that receives a DIO message, and has not already joined the DODAG, and is willing to do so, should add the DIO sender (the previous node through which the DIO has passed) to its parent list, compute its own rank (associated with the parent node) according to the OCP, and broadcast the DIO message with the updated rank information.

For a node which has already joined the DODAG, upon receiving another DIO message it may have the option to:
1. discard the DIO based on several criteria recommended by RPL;
2. process the DIO to maintain a position in an existing DAG; or
3. improve its position (by obtaining a lower rank) according to the OCP and current path cost.

After the DODAG is constructed, each non-root node will be able to forward any upward traffic (destined to the root node) to its parent as the next-hop node.

In order to support the outward traffic from the root to a non-root node, the non-root node should issue a control message called Destination Advertisement Object (DAO). As shown in FIG. 2, a DAO message is received by a root node in step S1-2. The information conveyed in the DAO message includes:
the rank information used by nodes to determine how far away the destination (the non-root node that issues the DAO, message) is; and
reverse route information to record the node visited along the outward path.

In passing this DAO, message from the non-root node to the root node according to the inward path indicated by the DAG, all of the intermediate nodes record the reverse path information from the DAO, message, and so a complete downward path is established from the root node to the non-root node.

In step S1-3, the root node checks whether a route has already been established between the root node and the non-root node from which it receives the DAO, message.

If yes, steps S1-1 to S1-3 are repeated. Otherwise, a route to that non-root node is added to establish a link between the root node and the non-root node.

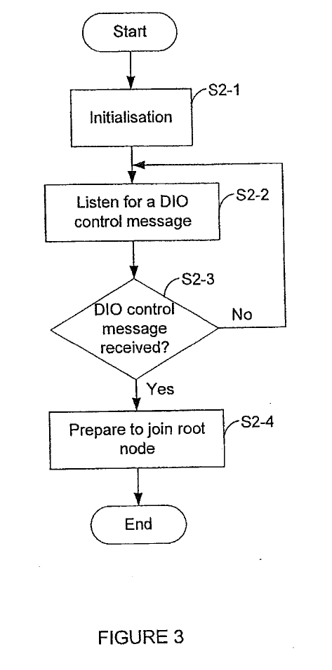

FIG. 3 illustrates a process which is carried out at a non-root node to establish a communication path with the root node.

Step S2-1: the process commences with an initialisation process which includes performing a channel scan to detect root nodes in its vicinity.

Step S2-2: the non-root node listens for a DIO control message.

Step S2-3: the non-root node checks whether a DIO control message is received.

If yes, the non-root node prepares to join the tree of the root node (step S2-4) which includes:
recording the DODAGID and rank information;
selecting and associating with a root with the lowest rank; and
preparing for transmission of a DAO control message to the associated root node.

To summarise the operation of RPL, any non-root node which is not part of a tree, upon receiving a DIO, will perform the following steps:
1. process the DIO;
2. join the tree of the root from which the DIO originated; and
3. send a DAO to the root node of this tree requesting it to setup a downward route.

Implementations of the embodiments described herein may provide an enhancement to the RPL protocol application in an AMI network.

According to one embodiment, there is provided a method of establishing a communication path in a sensor network, the sensor network having a tree structure comprising a plurality of root nodes representative of access point devices in said sensor network, and at least one non-root node representative of a sensor device in said sensor network, wherein each node in said sensor network is associated with a rank value determining its position relative to other nodes, such that said non-root node has higher rank value than said root node, the method comprising forwarding a control message from each root node in a subset of said plurality of root nodes to said at least one non-root node, the control message comprising a tree size value associated with said each root node in said subset, the tree size value defining the number of non-root nodes associated with each root node in said subset, and upon reception of said control message, selecting one of said root nodes in said subset to establish a communication path between said at least one non-root node, based on said tree size values of said root nodes in said subset, such that tree sizes of said each root node in said subset is substantially balanced relative to each other.

The method may further comprise determining a selection metric at said non-root node upon reception of said control message.

The selection metric may comprise a function of said tree size value and said rank value.

The selected root node may comprise a lower selection metric relative to selection metrics of remaining root nodes in said subset.

The above method may further comprise forwarding a further control message from said at least one non-root node to said selected root node, wherein said further control message indicates an intention of said at least one non-root node to establish a communication path with said selected root node.

The method may further comprise incrementing said tree size value of said selected root node upon establishing said communication path.

According to a second embodiment, there is provided a method of establishing a communication path in a sensor network, the sensor network having a tree structure comprising a plurality of root nodes representative of access point devices in said sensor network, and at least one non-root node representative of a sensor device in said sensor network, wherein each node in said sensor network is associated with a rank value determining its position relative to other nodes, such that said non-root node has higher rank value than said root node, the method being performed at said at least one non-root node, and the method comprising receiving a control message from each root node in a subset of a plurality of root nodes, the control message comprising a tree size value associated with said each root node in said subset, the tree size value defining the number of non-root nodes associated with each root node in said subset, and upon reception of said control message, selecting one of said root nodes in said subset to establish a communication path between said at least one non-root node, based on said tree size values of said root nodes in said subset, such that tree sizes of said each root node in said subset is substantially balanced relative to each other.

The method may further comprise determining a selection metric upon reception of said control message.

The selection metric may comprise a function of said tree size value and said rank value.

The selected root node may comprise a lower selection metric relative to selection metrics of remaining root nodes in said subset.

The method may further comprise forwarding a further control message to said selected root node, wherein said further control message indicates an intention to establish a communication path with said selected root node.

According to a third embodiment, there is provided a method of establishing a communication path in a sensor network, the sensor network having a tree structure comprising a plurality of root nodes representative of access point devices in said sensor network, and at least one non-root node representative of a sensor device in said sensor network, wherein each node in said sensor network is associated with a rank value determining its position relative to other nodes, such that said non-root node has higher rank value than said root node, the method being performed at each root node in a subset of said plurality of root nodes, and the method comprising forwarding a control message to said at least one non-root node, the control message comprising a tree size value associated with each root node in said subset, the tree size value defining the number of non-root nodes associated with each root node in said subset, receiving a further control message from said at least one non-root node, if the root node in said subset has been selected by said at least one non-root node to establish a communication path, and wherein said further control message indicates an intention of said at least one non-root node to establish a communication path with said selected root node.

The method may further comprise establishing said communication path with said at least one non-root node upon reception of said further control message.

The method may further comprise incrementing said tree size value upon establishing said communication path.

According to a fourth embodiment, there is provided a sensor network comprising a plurality of access point devices and at least one sensor device, and each devices in said sensor network is assigned with a rank value determining its position relative to other devices in the network, such that said sensor device has a higher rank value than said access point device, wherein said each of said plurality of access point devices is operable to forward a control message to said at least one sensor device, the control message comprising a network size value associated with said each of said access point devices, the tree size value defining the number of sensor devices associated with each of said access point devices, and said at least one sensor device is operable to, upon reception of said control message from each access point device in a subset of said plurality of access point devices, select one of said access point devices in said subset to establish a communication path between said at least one sensor device based on said network size values of said access point devices in said subset, such that network sizes of said each access point device is substantially balanced relative to each other.

The at least one sensor device may be operable to determine a selection metric upon reception of said control message.

The selection metric may comprise a function of said network size value and said rank value.

The selected access point device may comprise a lower selection metric relative to selection metrics of remaining access point devices in said subset.

The at least one sensor device may be further operable to forward a further control message to said selected access point device, wherein said further control message indicates an intention of said at least one sensor device to establish a communication path with said selected access point device.

The selected access point device may be operable to increment said network size value upon establishing said communication path.

According to a fifth embodiment, there is provided a sensor device for implementation in a sensor network comprising a plurality of access point devices and at least one sensor device, each devices in said sensor network is assigned with a rank value determining its position relative to other devices in the network, such that said sensor device has a higher rank value than said access point device, and the sensor device comprising a communication unit operable to receive a control message from each access point devices in a subset of said plurality of access point devices, the control message comprising a network size value associated with said each access point devices in said subset, the network size value defining the number of sensor devices associated with each access point devices in said subset, and a signal processor operable to select one of said access point devices in said subset to establish a communication path between said sensor device based on said network size values of said access point devices in said subset, such that network sizes of access point devices in said subset is substantially balanced relative to each other.

The signal processor may be further operable to determine a selection metric upon reception of said control message.

The selection metric may comprise a function of said network size value and said rank value.

The selected access point device may comprise a lower selection metric relative to selection metrics of remaining access point devices in said subset.

The communication unit may be further operable to transmit a further control message to said selected access point device, wherein said further control message indicates an intention to establish a communication path with said selected access point device.

According to a sixth embodiment, there is provided a sensor network comprising a plurality of access point devices and at least one sensor device, each devices in said sensor network is assigned with a rank value determining its position relative to other devices in the network, such that said sensor device has a higher rank value than said access point device, and each of said access point devices comprising a communication unit operable to forward a control message to said at least one sensor device, the control message comprising a network size value associated with said each of said access point devices, the network size value defining the number of sensor devices associated with said each of said access point devices, and said communication unit further operable to receive a further control message from said at least one sensor device, if the access point device has been selected by said at least one sensor device to establish a communication path, and wherein said further control message indicates an intention of said at least one sensor device to establish a communication path with said selected access point device.

The communication unit may be further operable to establish said communication path with said at least one sensor device upon reception of said further control message.

The access point device may further comprise a signal processor operable to increment said network size value upon establishing said communication path.

One embodiment provides a computer program product comprising computer executable instructions which, when executed by a computer, cause the computer to perform a method as set out above. The computer program product may be embodied in a carrier medium, which may be a storage medium or a signal medium. A storage medium may include optical storage means, or magnetic storage means, or electronic storage means.

The described embodiments can be incorporated into a specific hardware device, a general purpose device configure by suitable software, or a combination of both. Aspects can be embodied in a software product, either as a complete software implementation, or as an add-on component for modification or enhancement of existing software (such as a plug in). Such a software product could be embodied in a carrier medium, such as a storage medium (e.g. an optical disk or a mass storage memory such as a FLASH memory) or a signal medium (such as a download). Specific hardware devices suitable for the embodiment could include an application specific device such as an ASIC, an FPGA or a DSP, or other dedicated functional hardware means. The reader will understand that none of the foregoing discussion of embodiment in software or hardware limits future implementation of the invention on yet to be discovered or defined means of execution.

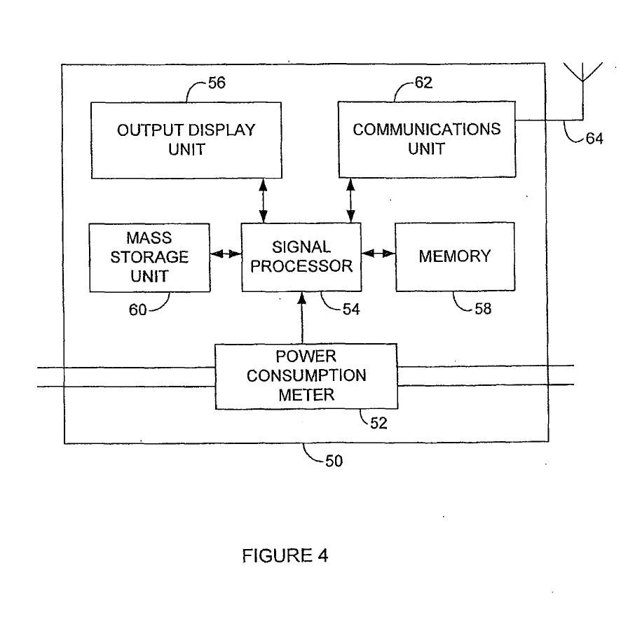

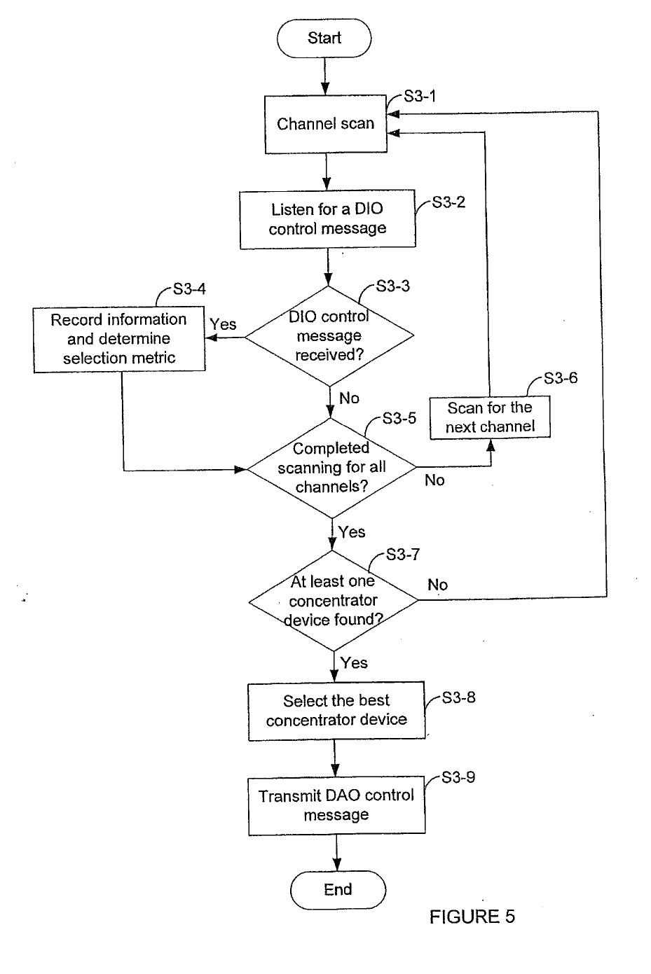

An embodiment will now be described with reference to FIGS. 4 and 5. This embodiment concerns an implementation of a smart meter device in the AMI network of FIG. 1.

As shown in FIG. 4, the smart meter device 50 comprises a power consumption meter 52 of conventional construction. Such meters generally measure instantaneous voltage and current at the point of measurement, to determine a measure of instantaneous power consumption. Over time, a measure of power consumption per period of time can be built up.

The power consumption meter 52 passes a power consumption signal to a signal processor 54, which processes the power consumption signal in a desired manner. Part of this processing is focused on monitoring energy consumption for billing purposes, but partly, also, the smart meter device is tasked with identifying activity which could be modified by the user to reduce or manage power consumption, such as by identifying connected equipment with high “stand by” usage, or usage which could be carried out at periods of low demand (such as recharge of night storage heaters, or use of large domestic appliances such as washing machines, dishwashers etc.). Such information as can be determined by the signal processor 54 in this way can be conveyed to the user with a suitable display unit 56. It would be appreciated by the skilled person that the display unit 56 can be integrated with the smart meter device 50, or can be provided as a separate unit connectable with the smart meter device 50.

It is also envisaged that the smart meter device 50 could have a capability to convey messages to control devices connected to the power supply, either by in-line communications and control devices, which might be embedded in a power supply plug or might be in the form of a device in-line between a power supply plug and corresponding socket. This capability might be wireless, or modulated onto the power supply itself (power line communication). The present disclosure is not directly concerned with such arrangements, but the above description is provided as context.

It is anticipated that, normally, no device would be removable from a smart meter, but the facility might exist for a memory card or the like to be connected thereto to introduce data or program information, or to extract data therefrom.

The signal processor 54 is operable to execute machine code instructions stored in a working memory 58 and/or retrievable from a mass storage unit 60. The smart meter device 50 also comprises a communications unit 62 connected to an antenna 64. In the illustrated embodiment in FIG. 4, the working memory stores executable instructions, when executed by the signal processor 54, establishes communication with concentrator devices, or other devices in the vicinity.

According to one embodiment, a method is carried out at the smart meter device to establish communication with concentrator devices in its vicinity. This process will now be described with reference to FIG. 5.

Step S3-1: an initialisation process is carried out which includes performing a channel scan to detect channels for establishing communication with concentrator devices in the AMI network.

Step S3-2: the smart meter device detects the presence of a DIO control message.

Step S3-3: the smart meter device periodically checks whether a DIO control message has been received.

If yes, in steps S3-4, the smart meter device records the root ID (DODAGID) of the concentrator device and its rank information. The number of smart meter devices associated with the concentrator device is also included in the DIO control message. As described in the preceding paragraphs, the concentrator network can be defined as a tree-like structure, and the number of smart meter devices associated to it is defined as the size of the tree (herein referred to as a tree size value).

The smart meter device also determines a selection metric, which is expressed as a function of rank and tree size, as follows:

selection metric=f(rank,trees size) (1)

Steps S3-5: check whether all the available channels have been scanned. Otherwise, the smart meter device will continue to scan for the next available channel (step S3-6).

Steps 33-7: check whether at least one concentrator device has been found. Otherwise, steps S3-1 to S3-6 are repeated.

Steps 3-8 select the “best” concentrator device to associate with, based on the calculated selection metric for each of the concentrator devices detected by the smart meter device 50. Once a concentrator device has been selected, the smart meter device will tune to the channel associated with this concentrator device.

In accordance with the RPL protocol, the smart meter device 50 also prepares to transmit a DAO control message to the associated concentrator device (step S3-9), indicating its intention to join its network.

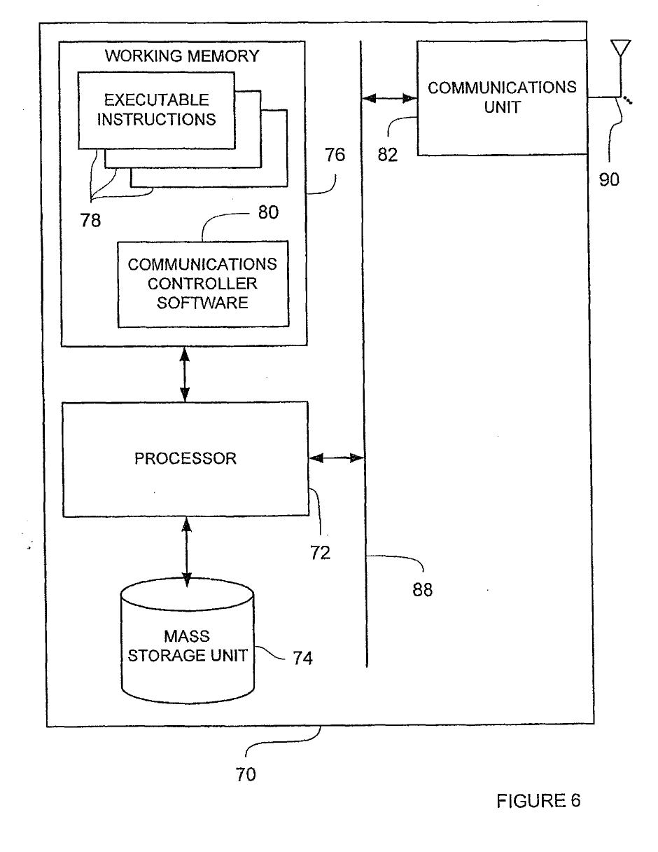

FIG. 6 illustrates schematically hardware operably configured (by means of software or application specific hardware components) as a concentrator device 70, according to one embodiment.

The concentrator device 70 illustrated in FIG. 6 is generally capable of being used to establish a communications channel with one or more other devices and, in accordance with a specific embodiment. The reader will appreciate that the actual implementation of the concentrator device is non-specific, in that it could be any communication device such as an access point station.

The device 70 comprises a processor 72 operable to execute machine code instructions stored in a working memory 74 and/or retrievable from a mass storage device 74.

A communications unit 82, connected to the general purpose bus 88, is connected to an antenna 90. In the illustrated embodiment in FIG. 6, the working memory 76 stores executable instructions, when executed by the processor 72, establishes communication with other devices in the vicinity.

Communications facilities 80 in accordance with the specific embodiment are also stored in the working memory 76, for establishing a communications protocol to enable data generated in the execution of one of the applications 78 to be processed and then passed to the communications unit 82 for transmission and communication with another device, such as the smart meter device and/or the utility provider's management system. It will be understood that the software defining the applications 78 and the communications facilities 80 may be partly stored in the working memory 76 and the mass storage device 74, for convenience. A memory manager could optionally be provided to enable this to be managed effectively, to take account of the possible different speeds of access to data stored in the working memory 76 and the mass storage device 74.

On execution by the processor 72 of processor executable instructions corresponding with the communications facilities 80, the processor 72 is operable to establish communication with another device in accordance with a recognised communications protocol.

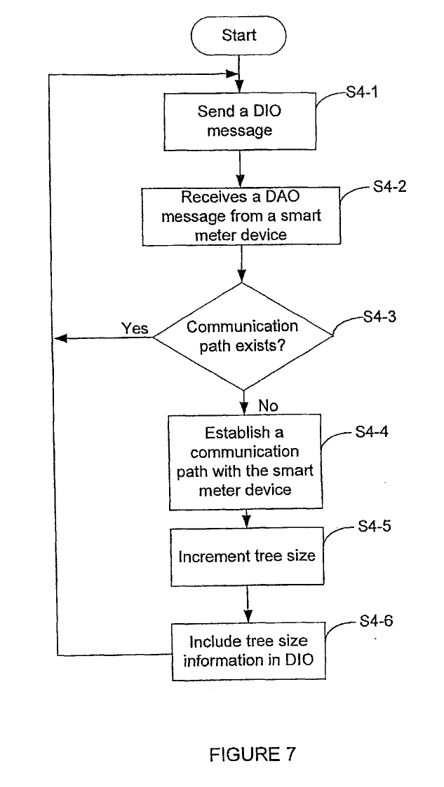

FIG. 7 illustrates a method, according to an embodiment, which is performed at a concentrator device when a smart meter device associates with the concentrator device.

Referring to FIG. 7, the concentrator device transmits a DIO control message to smart meter devices in its vicinity, in step S4-1. Upon receiving the DIO message, the smart meter devices decide whether they should join the network of this concentrator device by performing the methods described in the foregoing paragraphs, and illustrated with reference to FIG. 6. Once a smart meter device decides to associate with the concentrator device, it will transmit a DAO message to the concentrator device. The concentrator device receives the DAO message from the smart meter device in step S4-2.

In step S4-3, the concentrator device checks whether there is a communication path between the concentrator device and the smart meter device.

If yes, steps S4-1 to S4-3 will be repeated. Otherwise, a communication path will be established between the concentrator device and the smart meter device (step S4-4). Accordingly, the tree size value associated with the concentrator device is incremented (step S4-5). The updated tree size value is included in subsequent DIO control messages (step S4-6), and the process is repeated (steps S4-1 to S4-6). The updated DIO message will be transmitted to all the smart meter devices that are associated with the concentrator device as well as smart meter devices that intend to join the concentrator network.

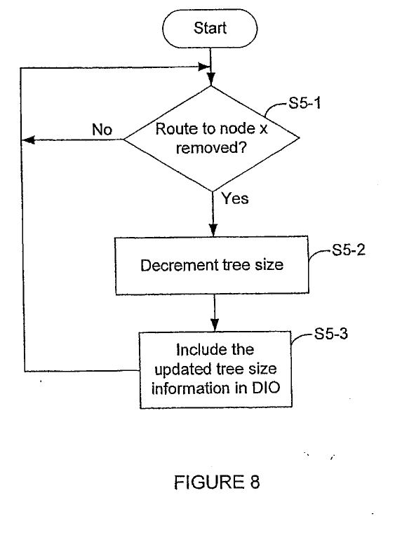

FIG. 8 illustrates a method which is performed at a concentrator device when a smart meter device leaves the network of the concentrator device. As illustrated in FIG. 8, the concentrator device determines whether a communication path between a smart meter device still exist (step S5-1). If yes, step 5-1 is repeated. Otherwise, the tree size value of the concentrator device is decremented accordingly in step S5-2. The updated tree size information is included in subsequent DIO control messages (step 5-3), and the process is repeated (steps S5-1 to S5-3).

The method of the described embodiments allows smart meter devices to make an informed decision before joining a network of a concentrator device. Furthermore, implementations of the described embodiments can be achieved without affecting compatibility with the standard RPL protocol. Indeed, an enhancement of the protocol is achieved by spreading load across concentrator devices in the vicinity of a smart meter device.

While certain embodiments have been described, these embodiments have been presented by way of example only, and are not intended to limit the scope of the inventions. Indeed, the novel methods, apparatus, and systems described herein may be embodied in a variety of other forms; furthermore, various omissions, substitutions and changes in the form of the methods, apparatus, and systems described herein may be made without departing from the spirit of the inventions. The accompanying claims and their equivalents are intended to cover such forms or modifications as would fall within the scope and sprit of the inventions.

1. A method of establishing a communication path in a sensor network, the sensor network having a tree structure comprising a plurality of root nodes representative of access point devices in said sensor network, and at least one non-root node representative of a sensor device in said sensor network, wherein each node in said sensor network is associated with a rank value determining its position relative to other nodes, such that said non-root node has higher rank value than said root node, the method comprising:
forwarding a control message from each root node in a subset of said plurality of root nodes to said at least one non-root node, the control message comprising a tree size value associated with said each root node in said subset, the tree size value defining the number of non-root nodes associated with each root node in said subset; and
upon reception of said control message, selecting one of said root nodes in said subset to establish a communication path between said at least one non-root node, based on said tree size values of said root nodes in said subset, such that tree sizes of said each root node in said subset is substantially balanced relative to each other.

2. A method according to claim 1, further comprising determining a selection metric at said non-root node upon reception of said control message.

3. A method according to claim 2, wherein said selection metric comprises a function of said tree size value and said rank value.

4. A method according to claim 2 or claim 3, wherein said selected root node comprises a lower selection metric relative to selection metrics of remaining root nodes in said subset.

5. A method of establishing a communication path in a sensor network, the sensor network having a tree structure comprising a plurality of root nodes representative of access point devices in said sensor network, and at least one non-root node representative of a sensor device in said sensor network, wherein each node in said sensor network is associated with a rank value determining its position relative to other nodes, such that said non-root node has higher rank value than said root node, the method being performed at said at least one non-root node, and the method comprising:
receiving a control message from each root node in a subset of a plurality of root nodes, the control message comprising a tree size value associated with said each root node in said subset, the tree size value defining the number of non-root nodes associated with each root node in said subset; and
upon reception of said control message, selecting one of said root nodes in said subset to establish a communication path between said at least one non-root node, based on said tree size values of said root nodes in said subset, such that tree sizes of said each root node in said subset is substantially balanced relative to each other.

6. A method according to claim 5, further comprising determining a selection metric upon reception of said control message.

7. A method according to claim 6, wherein said selection metric comprises a function of said tree size value and said rank value.

8. A method according to claim 6 or claim 7, wherein said selected root node comprises a lower selection metric relative to selection metrics of remaining root nodes of said subset.

9. A method of establishing a communication path in a sensor network, the sensor network having a tree structure comprising a plurality of root nodes representative of access point devices in said sensor network, and at least one non-root node representative of a sensor device in said sensor network, wherein each node in said sensor network is associated with a rank value determining its position relative to other nodes, such that said non-root node has higher rank value than said root node, the method being performed at each root node in a subset of said plurality of root nodes, and the method comprising:
forwarding a control message to said at least one non-root node, the control message comprising a tree size value associated with each root node in said subset, the tree size value defining the number of non-root nodes associated with each root node in said subset;
receiving a further control message from said at least one non-root node, if the root node in said subset has been selected by said at least one non-root node to establish a communication path; and
wherein said further control message indicates an intention of said at least one non-root node to establish a communication path with said selected root node.

10. A computer program product comprising computer executable instructions to cause a computer to become configured to perform a method according to any one of the preceding claims.

11. A computer product according to claim 10 comprising a computer readable storage medium.

12. A computer program product according to claim 10 comprising a computer receivable signal.

13. A sensor network comprising a plurality of access point devices and at least one sensor device, each devices in said sensor network is assigned with a rank value determining its position relative to other devices in the network, such that said sensor device has a higher rank value than said access point device,
wherein said each of said plurality of access point devices is operable to forward a control message to said at least one sensor device, the control message comprising a network size value associated with said each of said access point devices, the network size value defining the number of sensor devices associated with each of said access point devices; and
said at least sensor device is operable to, upon reception of said control message from each access point device in a subset of said plurality of access point devices, select one of said access point devices in said subset to establish a communication path between said at least one sensor device based on said network size values of said access point devices in said subset, such that network sizes of said each access point device is substantially balanced relative to each other.

14. A sensor network according to claim 13, wherein said at least one sensor device is operable to determine a selection metric upon reception of said control message.

15. A sensor network according to claim 14, wherein said selection metric comprises a function of said network size value and said rank value.

16. A sensor network according to claim 14 or claim 15, wherein said selected access point device comprises a lower selection metric relative to selection metrics of remaining access point devices in said subset.

17. A sensor device for implementation in a sensor network comprising a plurality of access point devices and at least one sensor device, each devices in said sensor network is assigned with a rank value determining its position relative to other devices in the network, such that said sensor device has a higher rank value than said access point device, and the sensor device comprising:
a communication unit operable to receive a control message from each access point devices in a subset of said plurality of access point devices, the control message comprising a network size value associated with said each access point devices in said subset, the network size value defining the number of sensor devices associated with each access point devices in said subset; and
a signal processor operable to select one of said access point devices in said subset to establish a communication path between said sensor device based on said network size values of said access point devices in said subset, such that network sizes of access point devices in said subset is substantially balanced relative to each other.

18. A sensor device according to claim 17, wherein said signal processor is further operable to determine a selection metric upon reception of said control message.

19. A sensor device according to claim 18, wherein said selection metric comprises a function of said network size value and said rank value.

20. An access point device for implementation in a sensor network comprising a plurality of access point devices and at least one sensor device, each devices in said sensor network is assigned with a rank value determining its position relative to other devices in the network, such that said sensor device has a higher rank value than said access point device, and each of said access point devices comprising:
a communication unit operable to forward a control message to said at least one sensor device, the control message comprising a network size value associated with said access point device, the network size value defining the number of sensor devices associated with said access point device;
and said communication unit further operable to receive a further control message from said at least one sensor device, if said access point device has been selected by said at least one sensor device to establish a communication path, and wherein said further control message indicates an intention of said at least one sensor device to establish a communication path with said access point device.
